(19) United States
(12) Patent Application Publication
(10) Pub. No.: US 2026/0366568 A1
(43) Pub. Date: Nov. 19, 2026

(54) BEARING CAGE FOR A ROLLER BEARING

(71) Applicant: AKTIEBOLAGET SKF, GOTEBORG (SE)

(72) Inventors: Marcus Maria Jochen BOEHM, Gädheim (DE); Gijsbert Willem DE KORT, Hertogenbosch (NL); Gerrit-Jan DOP, Alphen aan den Rijn (NL); Stefan ENGBERS, Neuenkirchen (DE); Thomas FRANZEL, Theres (DE); Dominik FRITZ, Würzburg (DE); Sabine HOFMANN, Kürnach (DE); Yuri KADIN, Nieuwegein (NL); Martin KEMMER, Werneck (DE); Philipp Thomas KIRCHNER, Volkach (DE); Thomas Bernd KRAUSE, Grafenrheinfeld (DE); Holger KRISTANDT, Euerbach (DE); Marcus PORATH, Freyenstein (DE); Juergen REICHERT, Donnersdorf (DE); Michael REUGELS, Knetzgau (DE); Richard Pieter SCHAAKE, Utrecht (NL); Jesko-Henning TANKE, Schweinfurt (DE); Stefan Manfred WEIGAND, Rannungen (DE)

(21) Appl. No.: 19/515,829

(22) PCT Filed: Sep. 10, 2024
(86) PCT No.: PCT/EP2024/075214

§ 371 Date: Mar. 3, 2026

(30) Foreign Application Priority Data
Sep. 12, 2023 (DE) 10 2023 208 860.6

(51) Int. Cl. F16C 33/46; F16C 33/51; F16C 33/66

(52) U.S. Cl. CPC F16C 33/467; F16C 33/516; F16C 33/6681

(57) ABSTRACT

A roller bearing cage segment includes two opposite circumferential webs and two opposite connecting webs that connect the circumferential webs to form a pocket. Each of the webs has a pocket side facing into the pocket that has a guide face with first and second portions and an ambient side outside the pocket that has a guide face with first and second portions. The first portions run straight in the radial direction, and the concave second portions are configured to face a convex surface of a roller in the pocket or outside the pocket adjacent to the cage segment. The concave second portion of the first guide face is configured to lie radially on a first side of a reference circle, and the concave second portion of the second guide face is configured to lie at least partially radially on a second side of the reference circle.

### TECHNICAL FIELD

The present invention relates to a bearing cage for a rolling bearing, according to the preamble of Patent claim 1. The invention furthermore relates to a rolling bearing, in particular a roller bearing, for mounting a first machine part so as to be rotatable relative to a second machine part, in particular for rotatably mounting a rotor shaft in a wind power installation.

In view of the increasing demand for ever larger rolling bearings, for example for wind power installations, cage concepts for ever higher mechanical loads are required. The dead weight of the rolling members used will increase in line with the size of the rolling bearings. Likewise, the diameter of the rolling members used can be enlarged so as to achieve a higher load rating for the rolling bearing at the same rolling bearing size. However, the dead weight of the rolling member generally also increases in line with the increase in the rolling member diameter. In view of the higher dead weight of the rolling members, ever more stable cage assemblies are required for this reason.

The invention is based on the object of specifying a cage design which is suitable for use in large rolling bearings in which rolling members with a great dead weight are used.

### SUMMARY OF THE INVENTION

This object is achieved by a bearing cage according to Patent claim 1.

Proposed hereunder is a cage segment for a rolling bearing, in particular for a roller bearing. For example, the rolling bearing can be a cylindrical roller bearing, a tapered roller bearing, etc. The cage segment comprises two mutually opposite circumferential webs and at least two mutually opposite connecting webs which connect the two circumferential webs to one another and, conjointly with the circumferential webs, form at least one pocket for receiving a rolling member. The circumferential webs can in each case extend between a first circumferential end and a second circumferential end of the cage segment. In particular, the circumferential webs can in each case start at one of the connecting webs and end at one of the connecting webs. The circumferential webs can have dissimilar lengths. Furthermore, the connecting webs can have dissimilar lengths.

The circumferential webs and the connecting webs have pocket sides which delimit the pocket and have ambient sides which oppose the pocket sides. At least one of the connecting webs on its pocket side has at least one first guide face, and on its ambient side has a second guide face. The at least one first and the at least one second guide face herein have at least one first portion which runs straight in the radial direction, wherein the at least one first guide face has at least one second portion which extends in the direction of a rolling member received in the pocket, and the at least one second guide face has at least one second portion which extends in the direction of a rolling member resting on the ambient side of the cage segment, wherein the second portion of the first guide face is disposed radially on a first side of the reference circle, and the second portion of the second guide face is disposed radially at least partially on a second side of the reference circle that lies opposite the first side.

The reference circle is the circle on which the centres of the rolling members move when the rolling bearing is in use. Furthermore, the term “the first portion runs straight in the radial direction” is understood to mean that the first portion does not have any curvature substantially along the radial direction. Furthermore, the first and the second guide face can be designed at least partially to partially encompass a rolling member in the circumferential direction of the latter.

The first side of the reference circle preferably lies radially inside, and the second side of the reference circle lies radially outside. Furthermore, the second portion of the first guide face and the second portion of the second guide face can be specified to raise the cage segment, for example in order to avoid excessive contact between one part of the cage segment and one part of the rolling bearing, such as a raceway, for example. For this purpose, the shape of the second portion of the second guide face can in particular be chosen in such a way that the cage segment is only raised to the extent that it does not come into contact with the second portion of the first guide face, and vice versa.

The cage segment has the advantage that it is suitable for use in very large rolling bearings and withstands the loads arising therein. In particular, the cage segment can be used in rolling bearings which use rolling members that have a great dead weight. Furthermore, the cage segment is distinguished in that it can be assembled with great ease, and at the same time offers low costs and a low weight. The pocket shape enables the rolling member to be securely received and the cage segment to be reliably guided on the rolling member.

According to one preferred embodiment, the second portion can be designed to be concave, or as a wrapping, respectively. This means that the second portion can have a curvature which is adapted to the rolling member. A rotation of the cage segment about a rotation axis of the rolling member can be reduced or prevented as a result, for example.

Alternatively, the second portion can be designed to be straight. Should the second portion be designed to be straight, the second portion can run at an inclination angle, which is between 10° and 37.5°, preferably 15 and 32.5°, in relation to the radial direction. A rotation of the cage segment about a rotation axis of the rolling member can be reduced or prevented as a result, for example.

Moreover, the first guide face can furthermore have at least one third portion which is provided in the radial direction between the first portion of the first guide face and the second portion of the first guide face and which is contactless in relation to the rolling member.

According to a further preferred exemplary embodiment, the second portion of the second guide face is connected to the first portion of the second guide face. Furthermore, the second guide face can have at least one third portion which extends in the direction of a rolling member resting on the ambient side of the cage segment and is disposed on that side of the first portion of the second guide face that lies opposite the second portion. This can make it possible to raise the cage segment, for example in order to avoid excessive contact between one part of the cage segment and one part of the rolling bearing, such as a raceway, for example. The third portion of the second guide face is preferably of identical shape to the second portion of the second guide face. Alternatively, the shape of the third portion of the second guide face and of the second portion of the second guide face can be dissimilar. In particular, the third portion of the second guide face can have a curvature which is adapted to the rolling member. Alternatively, the third portion of the second guide face can be designed to be straight.

Furthermore, the first guide faces and the second guide faces, in particular the second portions thereof, can be of identical or dissimilar shape. All of the connecting webs can be designed identically on their pocket sides and/or ambient sides.

The first guide faces and the second guide faces can be designed for frictional contact with the rolling member. The first guide faces and the second guide faces can in each case encompass the same circumferential region of the rolling member. Alternatively, one of the guide faces can encompass a larger circumferential region of the rolling member than the other guide face.

The first and the second guide faces can extend across a part of the length of the connecting webs, in particular across at least 30%, preferably 50%, even more preferably 60%, even more preferably 75%, even more preferably 90%, on the ambient sides and/or the pocket sides of the connecting webs.

The circumferential webs and the connecting webs can each have inner raceway sides which in the installed state of the cage segment point towards an inner rolling member raceway of the rolling bearing, and outer raceway sides which in the installed state of the cage segment point towards an outer rolling member raceway of the rolling bearing. The inner raceway sides and/or the outer raceway sides of the circumferential webs can in each case be formed in the region of the same pocket as flat, convex, concave and/or clearance surfaces. The inner raceway sides and/or the outer raceway sides of the connecting webs can be formed as flat, convex, concave and/or clearance surfaces.

The cage segment can have exactly one pocket. A cage segment designed in such a manner is distinguished by a particularly high level of mechanical stability and a high degree of universality in terms of use.

The cage segment can be made of plastics material and/or metal. The cage segment is preferably made by a casting method. For example, the cage segment can be formed by an injection-moulding method and/or a die-casting method. A cage segment formed in such a manner is in particular distinguished by its low weight, its cost-effective production and comparatively high flexibility. The cage segment can in particular be produced from polyamide, partially aromatic polyamide, polyether ether ketone, polyether sulfone, polyetherimide, polyaryl ether ketone, poly(methyl methacrylate), polyvinyl chloride, polyurethane, acrylonitrile butadiene styrene, polylactate, polycarbonate, polyethylene terephthalate, polyethylene, polypropylene, polystyrene, polyphthalamide, polyacetal, polyphenylene sulfide, polyimide, polyamide-imide, polysulfone, polyphenylene ether, polyarylamide, polybenzimidazole, polytetrafluoroethylene, polyvinylidene fluoride or liquid crystalline polymers. The cage segment is particularly preferably made of polyphenyl sulfide or of polyether ether ketone. Both materials are distinguished by being highly resistant to ageing and by a long service life, so that the cage segment can be used over a very long operating period. Furthermore, the cage segment can be formed from a light metal and/or a light metal alloy such as, for example, aluminium, an aluminium alloy, titanium, a titanium alloy, magnesium, a magnesium alloy, or the like. Alternatively or additionally, the cage segment can be made of a fibre-reinforced plastics material and/or a metal-reinforced plastics material. For example, a metal frame can be overmoulded with a plastics material in order to obtain the cage segment.

According to a further preferred embodiment, at least one connecting web on the ambient side and/or the pocket side in the axial direction has a first region and a second region. For example, a radially running depression can be provided between the first region and the second region. Furthermore, the connecting web in the circumferential direction can have a first thickness in the first region, and a second thickness in the second region, wherein the first thickness and the second thickness are dissimilar or identical. This can make it possible to adapt a play between the rolling member and the cage segment. Should the rolling member be a tapered roller in particular, the play between the cage segment and a large diameter of the tapered roller can be set independently of the play between the small diameter of the tapered roller and the cage segment. Furthermore, it is possible to respond to variances due to manufacturing tolerances, and/or when the first and the second thickness are conjointly altered, it is also possible to set a dimension of an end gap. Furthermore, an angle at which the two connecting webs run in relation to one another can also be easily set, so that the same casting mould can be used for a cage segment for tapered rollers as well as for a cage segment for cylindrical rollers.

The cage segment can preferably be guided by the rolling members and/or the ring and have at least one guide shoe which is provided on at least one connecting web and/or circumferential web and is designed to guide the cage segment on at least one part of a bearing ring. For example, the part of the bearing ring can be a shoulder of the bearing ring. In particular, the guide shoe can be formed as a protrusion which is provided for supporting the cage segment on at least one part of the bearing ring. The part of the bearing ring, for example a shoulder, can be formed on the inner ring and/or the outer ring. For example, at least one guide shoe can be provided in the region of a corner of the cage segment, i.e. in a region in which a circumferential web and a connecting web meet one another. Alternatively, at least one guide shoe can be provided on a circumferential web.

The cage segment can have a marking for unequivocally identifying the installed position. This facilitates the installation of the cage segment in the correct position in the rolling bearing.

According to a further preferred embodiment, at least one circumferential web on the pocket side has a radially running recess which is designed to separate the pocket side of the circumferential web into a first portion and a second portion. The first portion of the circumferential web and the second portion of the circumferential web can in particular be designed as a contact face for an end side of the rolling member.

If the cage segment is made by a casting method, in particular an injection-moulding method, a gate mark can preferably lie between the two portions, i.e. in the radially running recess. This has the advantage that the rolling member does not come into contact with the gate mark. The gate mark can be of a larger design as a result, for example. Owing to this fact, a filling and pressure behaviour which fully meets the requirements of injection-moulding can be implemented without limitations. Alternatively, a gate mark may also be provided at another location. For example, a gate mark can be provided on an ambient side of at least one circumferential web. This likewise has the advantage that the rolling member does not come into contact with the gate mark, and the gate mark can advantageously be of a larger design. It is also possible to provide the gate mark on the inner and/or outer raceway sides of the cage segment that lie opposite the raceways. Because any contact with the rolling members can also be advantageously avoided in this instance, as a result of which the above-mentioned advantages are likewise achieved.

Furthermore, at least one circumferential web on at least one radial edge can have at least one groove which is designed to direct a lubricant to the rolling member that is received in the pocket. This enables a sufficient amount of lubricant to make its way into the pocket.

The invention furthermore relates to a rolling bearing for mounting a first machine part so as to be rotatable relative to a second machine part. The rolling bearing has rolling members which each have a rotation axis. Furthermore, the rolling bearing has cage segments which each receive at least one rolling member and each have a first circumferential end and a second circumferential end. The cage segments are lined up next to one another in the circumferential direction of the rolling bearing in such a manner that one rolling member is in each case disposed between each two cage segments, said rolling member not being received in a cage segment and permanently preventing physical contact between these two cage segments.

A rolling bearing of this type of design is distinguished by positive running characteristics and a long service life.

The cage segments can be guided by the rolling member and/or the ring. This has the advantage that highly precise and low-wear guiding is possible.

The individual cage segments are preferably not mechanically connected to one another. This has the advantage that the cage segments are displaceable relative to one another in such a way that deformation and increased friction as well as increased wear arising in the process can be avoided. Furthermore, it can be achieved by the individual cage segments that the load acting on a respective cage segment is isolated, i.e. no loads emanating from rolling members of other regions act on the circumference of the cage segment.

Further advantages and advantageous embodiments are set forth in the description, the drawings and the claims. The combinations of features set forth in the description and in the drawings herein are in particular purely exemplary, so that the features may also be present individually or in other combinations.

### BRIEF DESCRIPTION OF THE FIGURES

The invention is to be described in more detail hereunder by means of exemplary embodiments illustrated in the drawings. The exemplary embodiments and the combinations shown in the exemplary embodiments herein are purely exemplary and are not intended to limit the scope of protection of the invention. The latter is defined solely by the appended claims.

In the drawings:

FIG. 1: shows a schematic view of a rolling bearing according to a first exemplary embodiment;

FIG. 2: shows a first perspective view of a cage segment for a rolling bearing according to a first exemplary embodiment;

FIG. 3: shows a second perspective view of the cage segment for a rolling bearing according to the first exemplary embodiment;

FIG. 4: shows a lateral view of the cage segment for a rolling bearing according to the first exemplary embodiment;

FIG. 5: shows a frontal view of the cage segment for a rolling bearing according to the first exemplary embodiment;

FIG. 6: shows a perspective view of a cage segment for a rolling bearing according to a second exemplary embodiment;

FIGS. 7 and 8: shows a schematic view of different exemplary embodiments for a first guide face of a cage segment;

FIGS. 9 and 10: show a schematic view of different exemplary embodiments for a second guide face of a cage segment;

FIG. 11: shows a lateral view of a cage segment for a rolling bearing according to a third exemplary embodiment; and

FIG. 12: shows a perspective view of a cage segment for a rolling bearing according to a fourth exemplary embodiment.

### DETAILED DESCRIPTION OF THE INVENTION

Identical or functionally equivalent elements are provided with the same reference signs hereunder.

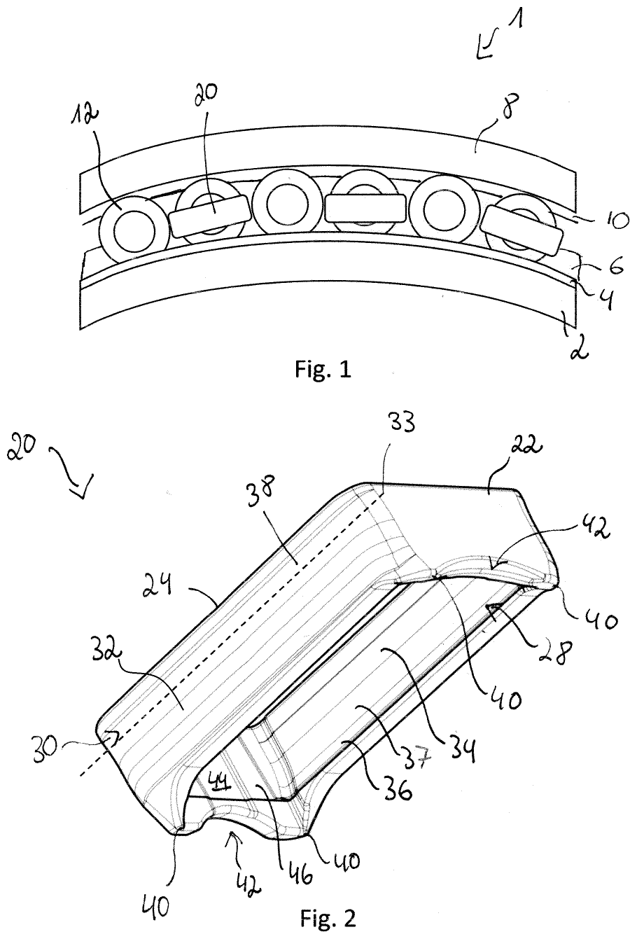

FIG. 1 shows an exemplary embodiment of a rolling bearing 1 according to the present invention in a schematic illustration. The rolling bearing 1 can in particular be a roller bearing such as, for example, a cylindrical roller bearing or a tapered roller bearing.

The rolling bearing 1 has an inner ring 2 having a run-up rim 4, or a guide rim, and an inner rolling member raceway 6, or inner ring raceway. The inner rolling member raceway 6 is partially obscured by the run-up rim 4 in the illustration of FIG. 1.

Furthermore, the rolling bearing 1 has an outer ring 8 having an outer rolling member raceway 10, or outer ring raceway. Moreover, the rolling bearing 1 has a set of rolling members 12 which roll on the inner rolling member raceway 6 and on the outer rolling member raceway 10. In the process, the rolling members 12 rotate about their rotation axes which are not illustrated in the figures, in relation to which the rolling members 12 are designed to be rotationally symmetrical. Moreover, the rolling members 12 in terms of their rotation axes run axially up to the run-up rim 4. Moreover, the rolling bearing 1 has a plurality of cage segments 20 which contain in each case one rolling member 12 in the exemplary embodiment illustrated.

However, only every second rolling member 12 is disposed in a cage segment 20 in such a way that one cage segment 20 with a rolling member 12 and one rolling member 12 without a cage segment 20 are in an alternating sequence in the circumferential direction of the rolling bearing 1. Cage segments 20 which are in each case successive in the circumferential direction are permanently spaced apart by one rolling member 12. This means that the cage segments 20 are not in mutual physical contact, regardless of the respective operating state of the rolling bearing 1.

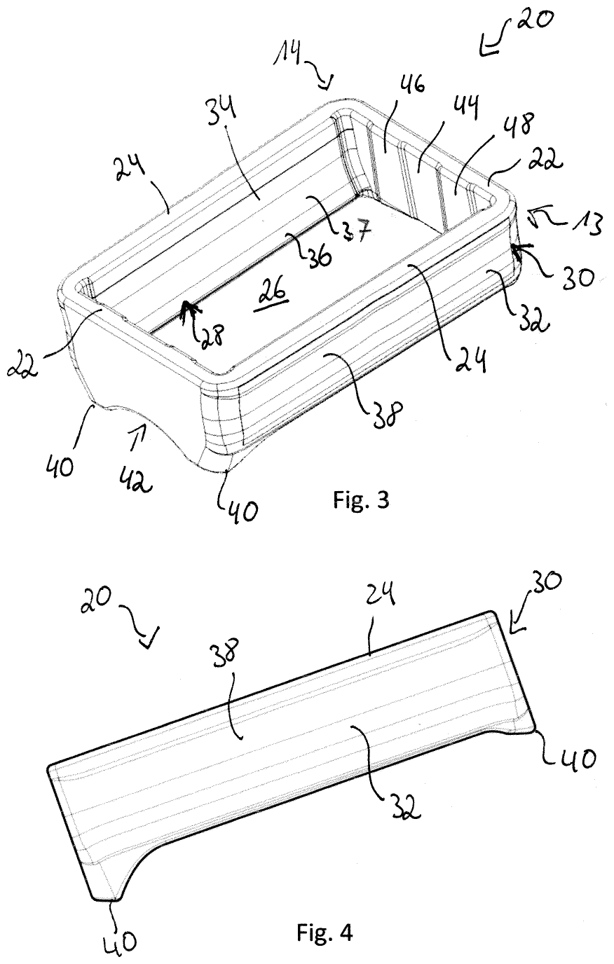

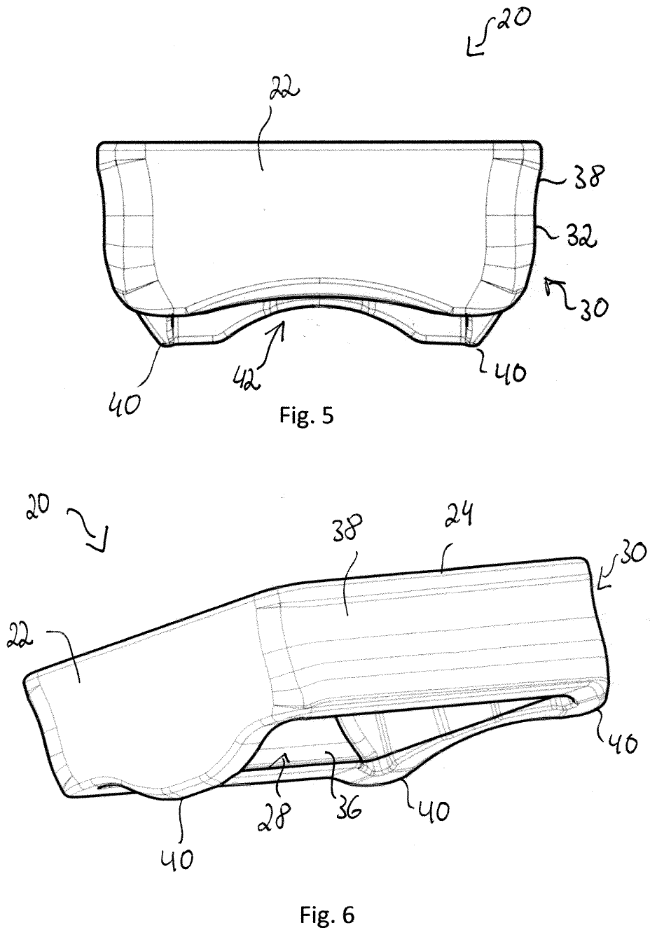

In the exemplary embodiment shown in FIG. 1, the cage segments 20 are guided by the rolling members, i.e. they are supported on the rolling members 12. Alternatively, the cage segments can also be guided on the inner ring 2 or on the outer ring 8. Furthermore, it is also possible to provide so-called mixed guiding in which the cage segments 20 are guided by the rolling members as well as the ring. Details pertaining to the design of the cage segments 20 are explained by means of FIGS. 2 to 12.

The inner ring 2 can be disposed on a shaft (not illustrated), for example. The shaft can in particular be a rotor shaft of a wind power installation. The outer ring 8 can be disposed in a housing (not illustrated) which can in particular be a constituent part of a rotor mounting of a wind power installation.

FIGS. 2 to 5 show a first exemplary embodiment of the cage segment 20 in a perspective illustration. The cage segment 20 has two circumferential webs 22 which are disposed at a mutual spacing and in the installed state of the cage segment 20 run in the circumferential direction of the rolling bearing 1.

Furthermore, the cage segment 20 has two connecting webs 24 which are disposed at a mutual spacing and connect the two circumferential webs 22 to one another. In this way, a pocket 26 for receiving one rolling member 12 is formed. Depending on whether the rolling members are cylindrical rollers or tapered rollers, the two connecting webs run so as to be mutually parallel or slightly oblique in relation to one another. In the case of a tapered roller bearing, the two circumferential webs 22 have a dissimilar length, and the pocket 26 has the shape of an isosceles trapezoid. In the case of a cylindrical roller bearing, the two circumferential webs 22 have the same length, and the pocket 26 has the shape of a rectangle. The length of the circumferential webs 22 is considered to be the external dimension of the circumferential webs 22 from a first circumferential end 13 up to a second circumferential end 14 of the cage segment 20. Should the first circumferential end 13 and the second circumferential end 14 of the circumferential webs 22 not in each case be oriented so as to be mutually parallel, the arithmetic mean value of the external dimension can in each case be utilised.

The sides of the circumferential webs 22 and of the connecting webs 24 that delimit the pocket 26 are also referred to as pocket sides hereunder. In an analogous manner, those sides of the circumferential webs 22 and connecting webs 24 that oppose the pocket sides are also referred to as ambient sides hereunder, unless said sides delimit a further pocket 26. This condition is generally met in the case of the circumferential webs 22, unless this is a cage segment 20 which has multiple rows in which a plurality of rolling members 12 are disposed axially behind one another. In the case of the connecting webs 24, this condition is in each case met when the respective connecting web 24 is disposed in the region of the first circumferential end 13 or of the second circumferential end 14 of the cage segment 20, i.e. for the first connecting web 24 and the last connecting web 24 of the cage segment 20 in terms of the circumferential direction of the rolling bearing 1. Since the exemplary embodiment of the cage segment 20 illustrated in FIG. 2 to FIG. 12 only has a single pocket 26, each circumferential web 22 and each connecting web 24 in this exemplary embodiment has in each case one pocket side and one ambient side.

As has already been mentioned, the circumferential webs 22 of a single-row cage segment 20 also have in each case one pocket side and one ambient side when the cage segment 20 has more than one pocket 26. In contrast, the connecting webs 24 in such a case can have in each case either one or two pocket sides, and thus either one or no ambient side. A connecting web 24 which is disposed between two pockets 26 has two pocket sides and no ambient side. A connecting web 24 which is at the end in the circumferential direction and delimits only a single pocket 26 has one pocket side and one ambient side.

Next to the pocket side and optionally the ambient side, the circumferential webs 22 and the connecting webs 24 have in each case an inner raceway side which in the installed state faces the inner rolling member raceway 6 of the rolling bearing 1, and an outer raceway side which in the installed state faces the outer rolling member raceway 10 of the rolling bearing.

The circumferential webs 22 are in particular formed so as to be integral to the connecting webs 24. This integral design can be achieved, for example, by manufacturing the cage segment 20 as a plastic injection-moulded part. Moreover, the circumferential webs 22 and the connecting webs 24 by way of their ambient sides terminate so as to be flush with one another in the region of the first circumferential end 13 and of the second circumferential end 14, i.e. neither the circumferential webs 22 protrude outwardly beyond the connecting webs 24, nor do the connecting webs 24 protrude outwardly beyond the circumferential webs 22.

The connecting webs 24 on their pocket sides have a first guide face 28 and on their ambient sides have a second guide face 30. The first and the second guide face 28, 30 have a first portion 32, 34 which runs straight in the radial direction. Furthermore, the first guide face 28 has a second portion 36 which extends in the direction of a rolling member received in the pocket. The second guide face 30 likewise has a second portion 38 which extends in the direction of a rolling member 12 resting on the ambient side of the cage segment. The second portion 36 of the first guide face 28 herein is disposed radially on a first side of the reference circle 33, and the second portion 38 of the second guide face 30 is disposed radially at least partially on a second side of the reference circle 33 that lies opposite the first side.

Furthermore, the first guide face 28 further comprises a third portion 37 which is provided in the radial direction between the first portion 32 and the second portion 36, wherein the third portion 37 is designed in such a way that it is contactless in relation to the rolling member 12.

The first guide face 28 and the second guide face 30 are designed to guide the cage segment 20 in a sliding manner on a rolling member 12 disposed within the cage segment 20, and on two rolling members 12 disposed directly next to the cage segment 20 on both sides. Only regions which in the operating state of the rolling bearing 1 can be in physical contact with the shell face of a rolling member 12 without deformation of the cage segment 20 are in each case considered to be part of the first guide face 28 and the second guide face 30.

The first and the second guide face 28, 30 in the radial direction have in each case at least one second portion 36, 38 which extends in the direction of the rolling member 12. Owing to this fact, it can be made possible that the rolling member is at least partially encompassed by the guide faces 28, 30. In the exemplary embodiments which are shown in FIGS. 2 to 7, 11 and 12, the second portion 36 of the first guide face 28 is designed to be straight. Furthermore, in the exemplary embodiments which are shown in FIGS. 2 to 6, and 10 to 12, the second portion 38 of the second guide face 30 is designed as a wrapping. This means that the second portion 38 has a curvature which is adapted to the rolling member 12. The first and the second guide faces 28, 30 on the pocket side and on the ambient side are dissimilarly designed in terms of their shape.

The cage segment 20 is guided by a shoulder and on its corners has in each case one guide shoe 40 which is formed as a protrusion and serves to support the cage segment 20 on the shoulder of the inner ring 2. A convexity 42 can be provided between the guide shoes 40, said convexity making it possible that a lubricant, in particular a lubricating oil, can be delivered to the rolling member 12 received in the pocket 26.

A radially running recess 44, which is designed to separate the pocket side of the circumferential web 22 into a first portion 46 and a second portion 48, is provided on the pocket side of the circumferential web 22. The first and the second portion 46, 48 of the circumferential web can in particular be designed as a contact face for an end side of the rolling member 12. If the cage segment 20 is made by an injection-moulding method, a gate mark can preferably lie between the two portions 46, 48, i.e. in the radially running recess 44.

FIG. 6 shows a perspective view of a cage segment 20 for a rolling bearing 1 according to a second exemplary embodiment. The cage segment of FIG. 6 differs from the cage segment 20 shown in FIGS. 2 to 5 in that the cage segment 20 of FIG. 6 has three guide shoes 40 instead of four guide shoes 40, wherein one of the three guide shoes is provided substantially in the centre of one of the circumferential webs 22, and the two other guide shoes 40 in each case are provided on the corners of the opposite circumferential web 22.

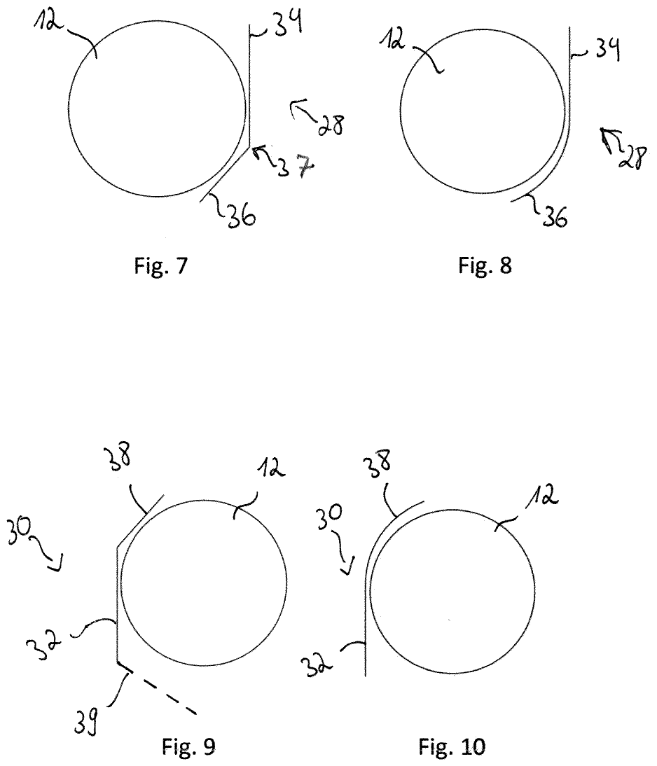

FIGS. 7 and 8 show a schematic view of different exemplary embodiments for a first guide face 28 of a cage segment 20.

As has already been described with reference to FIGS. 2 to 5, the first and the second guide face 28, 30 in the radial direction have in each case a second portion 36, 38 which extends in the direction of the rolling member 12. As can be seen in FIG. 7, the second portion 36 of the first guide face 28 can be designed to be straight. Furthermore, a third portion 37 can be provided in the first guide face 28 between the first portion 34 and the second portion 36, said third portion 37 being provided in the radial direction between the first portion 34 and the second portion 36 and being designed to be contactless in relation to the rolling member 12. Alternatively, the second portion 36 of the first guide face 28 can have a curvature with a constant or variable radius, as is shown in FIG. 8.

FIGS. 9 and 10 show a schematic view of different exemplary embodiments for a second guide face 30 of a cage segment. As can be seen in FIG. 9, the second portion 38 of the second guide face 30 can be designed to be straight. As is indicated by the dashed line 39, the second guide face 30 can optionally have a third portion 39 which extends in the direction of the rolling member 12 resting on the ambient side of the cage segment 20 and is disposed on that side of the first portion 32 of the second guide face 30 that lies opposite the second portion 38. As is shown in FIG. 9, the third portion 39 can have the same shape as the second portion 38, or have a shape which differs from the shape of the second portion 38. Alternatively, as is shown in FIG. 10, the second portion 38 can have a curvature with a constant or a variable radius. It is likewise possible to provide the second guide face 30, illustrated in FIG. 10, with a third portion 39 as indicated in FIG. 9.

Should the second portion 36, 38, or the third portion 39, of the second guide face 30 be designed to be straight, the second portion 36, 38, or the third portion 39, of the second guide face 30 can run at an inclination angle in relation to the radial direction, said inclination angle being between 10° and 37.5°, preferably 15 and 32.5°.

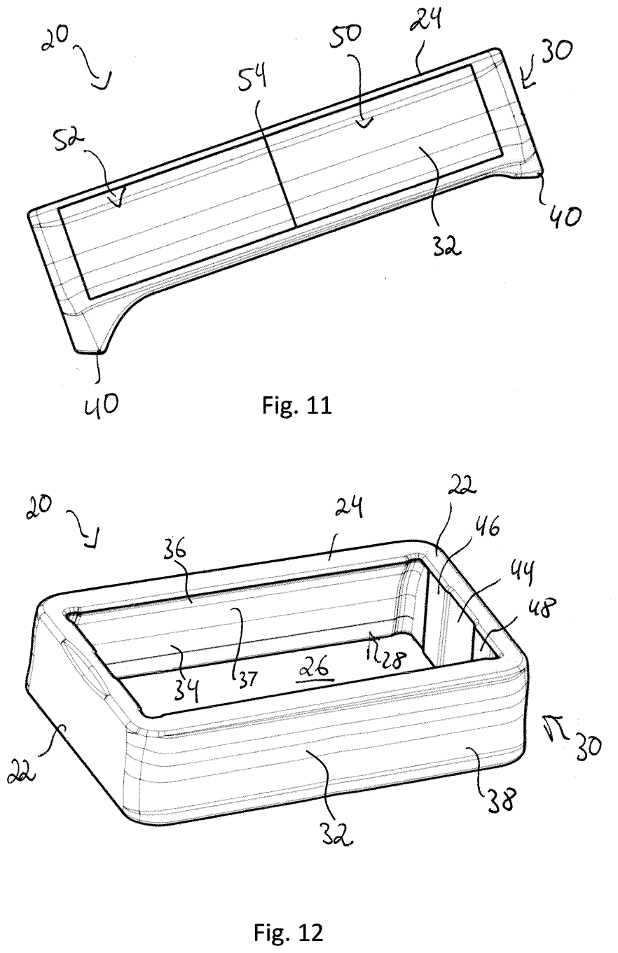

FIG. 11 shows a lateral view of a cage segment 20 for a rolling bearing according to a third exemplary embodiment. The cage segment of FIG. 11 differs from the cage segment 20 shown in FIGS. 2 to 5 in that the connecting webs 24 in the cage segment 20 of FIG. 11 on the ambient side in the axial direction have a first region 50 and a second region 52 which are separated from one another by a radially running depression 54. Furthermore, the connecting web in the circumferential direction can have a first thickness in the first region 50 and a second thickness in the second region 52, wherein the first thickness and the second thickness are identical or dissimilar. This means that the thicknesses of the two regions 50, 52 can be set independently from one another. For example in the case of variances resulting from the casting process, this enables the regions 50, 52 to be readjusted independently of one another. Furthermore, a play between the rolling member 12 and the cage segment 20 can be adapted by way of the thicknesses of the regions 50, 52.

FIG. 12 shows a perspective view of a cage segment 20 for a rolling bearing 1 according to a fourth exemplary embodiment. The cage segment of FIG. 12 differs from the cage segment 20 shown in FIGS. 2 to 5 in that the cage segment 20 of FIG. 12 does not have any guide shoes 40 and is thus guided only by rolling members.

### LIST OF REFERENCE SIGNS

1 Rolling bearing
2 Inner ring
4 Guide rim
6 Inner ringway
8 Outer ring
10 Outer ringway
12 Rolling member
13 First circumferential end
14 Second circumferential end
20 Cage segment
22 Circumferential web
24 Connecting web
26 Pocket
28 First guide face
30 Second guide face
32, 34 First portion
33 Reference circle
36, 38 Second portion
37, 39 Third portion
40 Guide shoe
42 Convexity
44 Recess
46 First portion
48 Second portion
50 First region
52 Second region
54 Depression

1. A cage segment for a roller bearing the cage segment being configured to retain a first roller having predetermined dimensions and to abut a second roller having the predetermined dimensions, the cage segment comprising:
two mutually opposite circumferential webs, and
two mutually opposite connecting webs that connect the two circumferential webs to one another and together with the circumferential webs, form a pocket,
wherein each of the circumferential webs and each of the connecting webs has a pocket side delimiting the pocket and an ambient side opposite the respective pocket side,
wherein the pocket side of a first one of the connecting webs has a first guide face and the ambient side of the first one of the connecting webs has a second guide face,
wherein first guide face and the second guide face each have a first portion which runs straight in the radial direction,
wherein the first guide face has a concave second portion configured to face a convex surface of the first roller retained in the pocket, and the second guide face has a concave second portion configured to face a convex surface of the second roller abutting on the ambient side of the first one of the connecting webs,
wherein the concave second portion of the first guide face is configured to lie radially on a first side of a reference circle, and the concave second portion of the second guide face is configured to lie at least partially radially on a second side of the reference circle, and
wherein the reference circle is a circle on which a center of a first end face of the first roller and a center of an end face of the second roller will lie when the first roller is retained in the pocket and the second roller abuts the ambient side of the first one of the connecting webs.

2. (canceled)

3. The cage segment according to claim 1,
wherein the concave second portion is straight.

4. The cage segment according to claim 1,
wherein the first guide face has a third portion between the first portion of the first guide face and the concave second portion of the first guide face configured to remain spaced from the first roller when the first roller contacts the first portion of the first guide face and the concave second portion of the first guide face.

5. The cage segment according to claim 1,
wherein the concave second portion of the second guide face adjoins the first portion of the second guide face, and
wherein the second guide face includes a third portion on a side of the first portion of the second guide face opposite the second portion of the second guide face.

6. The cage segment according to claim 1,
wherein the pocket side of the first one of the connecting webs and/or the ambient side of the first one of the connecting webs includes a radially running depression separating the pocket side of the first one of the connecting webs into a first pocket-side region and a second pocket-side region and/or separating the ambient side of the first one of the connecting webs into a first ambient-side region and a second ambient-side region.

7. The cage segment according to claim 1,
including at least one guide shoe configured to guide the cage segment on a bearing ring.

8. The cage segment according to claim 1,
wherein a pocket side of a first one of the circumferential webs has a radially running recess separating the pocket side of the first circumferential web into a first portion and a second portion.

9. The cage segment according to claim 1,
wherein the cage segment comprises a plastic material and/or a metal.

10. The cage segment according to claim 1,
wherein a radial edge of a first one of the circumferential webs includes at least one groove configured to direct a lubricant to the roller in the pocket.

11. (canceled)

12. A roller bearing comprising:
a first bearing ring having a first raceway,
a second bearing ring having a second raceway,
the first roller and the second roller arranged between and configured to roll on the first raceway and the second raceway, and
the cage segment according to claim 1 arranged between the first raceway and the second raceway such that the first roller is located in the pocket and the second roller is in direct contact with the second guide face of the first one of the connecting webs of the cage segment.

13. The roller bearing according to claim 12,
wherein the first guide face has a third portion between the first portion of the first guide face and the concave second portion of the first guide face that remains spaced from the first roller when the first roller contacts the first portion of the first guide face and the concave second portion of the first guide face.

14. The cage segment according to claim 14,
wherein a radial edge of a first one of the circumferential webs includes at least one groove configured to direct a lubricant to the roller in the pocket.
